(19) United States
(12) Patent Application Publication
(10) Pub. No.: US 2017/0334170 A1
(43) Pub. Date: Nov. 23, 2017

(54) ARTICLES INCLUDING ADHESION ENHANCING COATINGS AND METHODS OF PRODUCING THEM

(71) Applicants: Atieh Haghdoost, San Pablo, CA (US); Mehdi Kargar, San Pablo, CA (US)

(72) Inventors: Atieh Haghdoost, San Pablo, CA (US); Mehdi Kargar, San Pablo, CA (US)

(21) Appl. No.: 15/467,469

(22) Filed: Mar. 23, 2017

Related U.S. Application Data
(63) Continuation-in-part of application No. 15/392,330, filed on Dec. 28, 2016.
(60) Provisional application No. 62/312,267, filed on Mar. 23, 2016.
(60) Provisional application No. 62/358,513, filed on Jul. 5, 2016.

(51) Int. Cl. B32B 15/04; B32B 3/18; B32B 5/16; B32B 15/20

(52) U.S. Cl. CPC B32B 15/04; B32B 15/20; B32B 3/18; B32B 5/16

(57) ABSTRACT

Certain embodiments are described herein that are directed to articles comprising textured coatings that can enhance adhesion of a surface coating. In some examples, the textured coating comprises at least one metal or metallic compound present in a plurality of individual microstructures which can be positioned in different planes in different heights with respect to a reference zero point in the textured coating. In some configurations, a surface coating comprising a repellent material can be disposed onto the textured coating and may infuse into or grip the textured coating to enhance adhesion of the surface coating.

### PRIORITY CLAIM

This application claims priority to, and the benefit of, U.S. Provisional Application No. 62/312,267 filed on Mar. 23, 2016, to U.S. Provisional Application No. 62/358,513 filed on Jul. 5, 2016 and to U.S. application Ser. No. 15/392,330 filed on Dec. 28, 2016, the entire disclosure of each of which is hereby incorporated herein by reference for all purposes.

### TECHNOLOGICAL FIELD

Certain configurations described herein are directed to articles which comprise coatings that can enhance or increase adhesion of a surface coating in the article and methods of producing such articles. In some examples, the article can be produced by electrodepositing a textured coating on a substrate and then disposing a surface coating on the electrodeposited, textured coating.

### BACKGROUND

Many articles are coated with one or more materials to impart some functional or aesthetic characteristics to the article. The coatings can be deposited in numerous ways.

### SUMMARY

In one aspect, an article comprises a substrate, a textured coating comprising a repellent material disposed on the substrate, and a surface coating disposed on the textured coating, wherein in the absence of the textured coating a pull-off strength of the surface coating is lower than in the presence of the textured coating when the pull-off strength is tested by ASTM D4541-09.

In some configurations, the textured coating comprises a plurality of individual microstructures of an average characteristic length which comprise a metal or metallic compound, wherein the plurality of individual microstructures are positioned in different planes and in different heights with respect to a reference zero point in the textured coating. In certain examples, the textured coating comprises nickel, zinc, chromium, copper, zinc/nickel alloys, zinc/copper alloys, chromium alloys and combinations thereof. In other examples, the textured coating comprises silicon carbide, polytetrafluoroethylene, silicon oxide, diamond, titanium dioxide or silicon oxide particles, microparticles or nanoparticles. In some embodiments, the textured coating comprises an electrodeposited, textured coating. In certain examples, a water contact angle of the surface coating is at least 80 degrees. In other embodiments, the electrodeposited, textured coating comprises a plurality of individual microstructures of an average characteristic length which comprise a metal or metallic compound, wherein the plurality of individual microstructures are positioned in different planes and in different heights with respect to a reference zero point in the electrodeposited, textured coating. In some instances, the textured coating comprises silicon carbide, polytetrafluoroethylene, silicon oxide, diamond, titanium dioxide or silicon oxide particles, microparticles or nanoparticles. In other configurations, the textured coating comprises a first textured coating and a second textured coating. In certain examples, the repellent material comprises one or more of a silicone polymer, e.g., polydimethylsiloxane, a fluorinated polymer, e.g., polytetrafluorethylene, an oligomeric siloxane, e.g., fluorinated-base oligomeric siloxane, a ceramic material, e.g., hydrophobic silica particles or alumina particles, a metal compound e.g., molybdenum disulfide, and combinations thereof.

In another aspect, an article comprises a substrate, a textured coating disposed on the substrate, wherein the textured coating comprises at least 70% by volume inorganic material, and a surface coating comprising a repellent material, wherein the repellent material is disposed on the textured coating and infuses into space in the textured coating to partially or completely fill space between microstructures of the textured coating, wherein in the absence of the textured coating a pull-off strength of the surface coating is lower than in the presence of the textured coating when the pull-off strength is tested by ASTM D4541-09.

In certain examples, the textured coating comprises a plurality of individual microstructures of an average characteristic length which comprise a metal or metallic compound, wherein the plurality of individual microstructures are positioned in different planes and in different heights with respect to a reference zero point in the textured coating. In other examples, the inorganic material of the textured coating comprises nickel, zinc, chromium, copper, zinc/nickel alloys, zinc/copper alloys, chromium alloys and combinations thereof. In some embodiments, the textured coating comprises silicon carbide, polytetrafluoroethylene, silicon oxide, diamond, titanium dioxide or silicon oxide particles, microparticles or nanoparticles. In other embodiments, the textured coating comprises an electrodeposited, textured coating. In some examples, a water contact angle of the surface coating is at least 80 degrees. In certain examples, the repellent material comprises one or more of a silicone polymer, e.g., polydimethylsiloxane, a fluorinated polymer, e.g., polytetrafluorethylene, an oligomeric siloxane, e.g., fluorinated-base oligomeric siloxane, a ceramic material, e.g., hydrophobic silica particles or alumina particles, a metal compound e.g., molybdenum disulfide, and combinations thereof. In certain instances, the textured coating comprises silicon carbide, polytetrafluoroethylene, silicon oxide, diamond, titanium dioxide or silicon oxide particles, microparticles or nanoparticles. In some examples, the textured coating comprises a first textured coating and a second textured coating. In certain examples, the first textured coating comprises different shaped microstructures than the second textured coating.

In an additional aspect, a method of increasing adhesion of a surface coating to an article comprises providing a textured coating on a substrate by electrodepositing the textured coating, and disposing the surface coating on the electrodeposited, textured coating, wherein the pull-off strength of the disposed surface coating in the absence of the electrodeposited, textured coating is lower than in the presence of the electrodeposited, textured coating.

In another aspect, a method of increasing adhesion of a surface coating in an article comprises electrodepositing a textured coating on the substrate using an electrolyte solution comprising a mixture of at least one metal or metallic compound, wherein the textured coating comprises a plurality of individual microstructures of an average characteristic length which comprise the metal or metallic compound, wherein the plurality of individual microstructures are positioned in different planes and in different heights with respect to a reference zero point in the electrodeposited, textured coating, and disposing the surface coating on the electrodeposited textured coating by applying a repellent material onto the electrodeposited textured coating, wherein an average particle size of particles of the repellent material is selected to be less than the average characteristic length of the plurality of individual microstructures of the electrodeposited, textured coating, and wherein pull-off strength of the disposed surface coating in the absence of the electrodeposited, textured coating is lower than in the presence of the electrodeposited, textured coating.

In an additional aspect, kits comprising the various components and materials used to provide the articles are also described.

Additional aspects, embodiments, configurations and examples are discussed in more detail herein.

### BRIEF DESCRIPTION OF THE FIGURES

Certain embodiments and configurations are described with reference to the figures in which:

FIG. 1 is an illustration showing a textured coating on a metallic substrate and a surface coating on the textured coating, in accordance with certain examples;

FIG. 2 is schematic of an electrodeposition system, in accordance with certain examples;

FIGS. 3A, 3B and 3C show microstructures of an electrodeposited textured coating with different geometrical shapes, in accordance with certain examples;

FIG. 4 is an illustration of an article comprising a substrate, a textured coating and a surface coating, in accordance with certain configurations;

FIG. 5 is another illustration of an article comprising a substrate, a textured coating and a surface coating, in accordance with certain configurations;

FIG. 6 is another illustration of an article comprising a substrate, a textured coating and a surface coating, in accordance with certain configurations;

FIG. 7A is an illustration of an article comprising a substrate with a textured coating on each surface and a surface coating on one of the textured coatings, in accordance with certain examples;

FIG. 7B is an illustration of an article comprising a substrate with a textured coating on each surface and a surface coating on each of the textured coatings, in accordance with certain examples;

FIG. 8 is an illustration of an article comprising two textured coatings and a surface coating, in accordance with certain configurations.

It will be recognized by the person of ordinary skill in the art, given the benefit of this disclosure, that the shapes, sizes and shading in the materials is provided for illustrative purposes only. No particular geometric shape, material or the like is intended to be implied by the representations in the figures unless stated otherwise in the accompanying description below.

### DETAILED DESCRIPTION

Certain embodiments described herein are directed to articles comprising at least one textured coating and/or a surface coating and methods of producing such articles. For example, the articles described herein may comprise one or more textured coatings which can be used to enhance adhesion or sticking of a surface coating. In some examples, the textured coating is provided using suitable techniques, e.g., electrodeposition, and comprises a plurality of individual microstructures of a first size, e.g., the microstructures may comprise an average diameter of 15 microns or less, or 10 microns or less or 5 microns or less or 0.5 microns or less. The surface coating can comprise particles or materials with an average size less than the first size of the microstructures of the textured coating. As noted herein, by tuning the size and/or shape of the textured coating and the material of the surface coating, enhanced adhesion of the surface coating can be achieved. For example, the adhesion or pull-off strength of the surface coating may be 10%, 20%, 30%, 40%, 50%, 60%, 70%, 80% or even 90% higher when the textured coating is present compared to the pull-off strength of the surface coating being disposed on a substrate not having the same textured coating. As discussed below, pull-off strength can be tested, for example, using ASTM D4541-09. In some configurations, the pull-off strength of the surface coating, when the textured coating is present, may be at least 200 psi, 225 psi or 250 psi as tested using ASTM D4541-09. In some examples, the coatings can be present as distinct layers with a defined interface, whereas in other instances, the coating materials may infuse or penetrate into each other without a discernible interface between them.

In certain examples, the articles described herein may also comprise a surface coating disposed on the textured coating. As noted in more detail below, the surface coating may comprise a repellent material, a material with a water contact angle greater than 80 degrees, a water roll off angle below 20 degrees, an oil roll off angle below 45 degrees and combinations thereof. Wetting properties of the surface can be measured based on the procedures explained in the following standards: ASTM D7490-13, ASTM D724-99, ASTM 0 5946-2004, and ISO 15989. In some examples, the repellent materials may generally be considered “non-stick” materials in the field of coatings. When the surface coating is absent, the overall surface roughness of the article is typically higher, e.g., surface roughness decreases after the surface coating is applied to the textured coating.

In certain configurations described herein, the textured coating can be configured as a porous coating to permit the surface coating material to penetrate or infuse into the void space of the textured coating. For example, there may be space between microstructures of the textured coating and/or space within the microstructures themselves that permits the surface coating material to infuse, enter or penetrate into the textured coating. Infusion or entry of the surface coating material into the textured coating can reduce the overall surface roughness, e.g., the surface roughness once the textured coating has been disposed on the article is much higher than the surface roughness once the surface coating has been disposed on the textured coating. As noted herein, the textured coating and surface coatings can each be applied in numerous manners including, but not limited to, brushing, spraying, dip-coating, jet coating or other methods. In some examples, the textured coating can be applied using electrodeposition and the surface coating can be applied using non-electrodeposition methods.

In other instances, a textured coating can be disposed on an already existing textured coating. For example, a substrate may comprise a first textured coating, and another textured coating can be disposed on the first textured coating. In other instances, a first textured coating can be applied to the substrate, e.g., using electrodeposition or other processes, and then a second textured coating can be applied to the substrate and/or the applied first textured coating. A surface coating can then be applied to the textured coatings on the substrate. In some case, the first and second textured coatings may comprise the same material but have different microstructures or topography. In other cases, the first and second textured coatings may comprise a different material but have similarly shaped microstructures or topography. In additional examples, the first and second textured coatings may comprise different materials and have different microstructures or topography. If desired, one or both of the first and second textured coatings can be electrodeposited onto a substrate, or, one of the textured coatings can be electrodeposited and the other textured coating can be disposed using means other than electrodeposition.

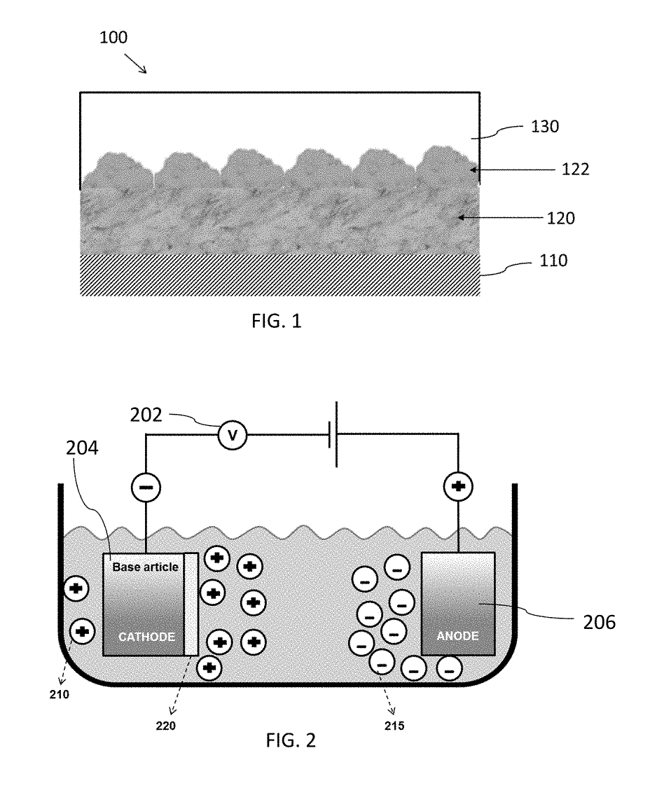

In certain examples and referring to FIG. 1, an article 100 is shown that comprises a substrate 110, a textured coating 120 disposed on the substrate 110 and an surface coating 130 disposed on the textured coating 120. As noted in more detail below, the textured coating may comprise one or more individual microstructures or features such as microstructure 122. The space present between various microstructures can be filled by material of the surface coating 130 to enhance grip or adhesion of the surface coating 130 in the article 100. Various materials for the substrate 110 are described below and include, for example, steels, steel alloys, steel comprising different grades of carbon steel or stainless steel. Similarly, various materials for the textured coating 120 are described below and include, but are not limited to, metals or metallic compounds optionally in combination with other materials. Various materials for the surface coating 130 are described below and include, but are not limited to, different polymers such as fluorinated or silicon-based polymers, ceramics, polymer blends, repellent and/or hydrophobic or superhydrophobic materials, nanoparticles, or any combination thereof such as polymer-nanoparticle composite materials. It is worth mentioning that repellent materials are defined as the materials that can repel one or more substances including, but not limited to, water, oil, smudge, dirt, and dust, for example.

In some embodiments, the textured coating 120 can be provided using one or more electrodeposition processes and/or systems. An illustrative system is shown in FIG. 2 and comprises a voltage source 202, a cathode 204 (which may be the substrate 110 or a separate electrode) and an anode 206 each electrically coupled to the voltage source 202. A solution comprising positive ions 210 and negative ions 215 can be used to provide a textured coating 220 on the substrate/cathode 204. While electrodeposition is shown in FIG. 2, additional process steps, such as, for example, grit blasting, plasma etching, electroless deposition, wet etching, ion milling, surface functionalization, electro-polymerization, spray coating, brush coating, electrophoretic deposition, thermal processes, vacuum conditioning, exposure to electromagnetic radiation such as visible light, UV, and x-ray exposure may also be performed. The electrolyte solution may also comprise other compounds including but not limited to ionic compounds to enhance electrolyte conductivity, buffer compounds to stabilize electrolyte pH, and different additives. Examples of additives include but not limited to thiourea, acetone, cadmium ion, chloride ion, stearic acid, ethylenediamine dihydrochloride, saccharin, cetyltrimethylammonium bromide, ethyl vanillin, ammonia, ethylene diamine, polyethylene glycol (PEG), bis(3-sulfopropyl)disulfide (SPS), Janus green B (JGB), the polyoxyethylene family of surface active agents, sodium citrate, perfluorinated alkylsulfate, additive K, ethylene diamine, ammonium chloride. In addition to these additives, one or more repellent or hydrophobic materials may also be present in the electrolyte solution itself, e.g., can be dispersed or suspended or dissolved in the electrolyte solution as desired. When a current is applied, the base article 204, e.g., the substrate, becomes negatively charged and attracts the positive ions 210 in the solution. The positive ions 210 are neutralized on the surface of the base article 204 and provide the textured coating 220 on the substrate 204. A constant, multistep or varying voltage can be applied. As a non-limiting example, a textured zinc coating can be electroplated onto a steel substrate from a solution that comprises zinc chloride, boric acid, and potassium chloride by applying a varying voltage from open circuit potential to a high voltage beyond the initiation of the gas formation. As another example, a textured copper coating can be electroplated onto a steel substrate from a solution that comprises copper sulfate and sulfuric acid by applying a varying voltage from open circuit potential to a high voltage beyond the initiation of the gas formation.

In some examples, the substrate can be cleaned or washed prior to deposition of the textured coating. Different cleaning processes including, but not limited to, pickling, acid wash, saponification, vapor degreasing, and alkaline wash may be used for cleaning the substrate. The cleaning process may include, but is not limited to, removal of the inactivate oxides by acid wash or pickling and catalytic deposition of a seed layer. If desired, however, the substrate may not be subjected to physical pre-treatment steps that significantly alter the overall surface characteristics of the substrate prior to electrodeposition of the textured coating. For example, the substrate can be washed or treated without significantly altering the native material present in the substrate or removal of any native material from the substrate. Similarly, if desired, the substrate may not be subjected to chemical pre-treatment steps that alter the overall surface characteristics of the substrate prior to electrodeposition of the textured coating or remove any significant amount of the native substrate material from the substrate prior to electrodeposition of the textured coating. The change in the surface characteristics and the amount of the material that is removed from the surface during the cleaning process is not considered significant.

In certain examples, and as a non-limiting example, a constant voltage in the range of −1 V to −10 V can be applied using the electrodeposition system. As another non-limiting example a constant current in the range of −0.01 to −0.1 mA/cm² can be applied using the electrodeposition system. Another non-limiting example is applying a varying voltage that alternates or swipes between the open circuit potential and a high voltage beyond the initiation of gas formation during the electrodeposition process. The electrodeposition process may be performed at a temperature ranging from 25 to 95° C. Moreover, the electrodeposition may be performed under non-agitation or agitation condition with the agitation rate of 0 to 800 rpm.

In addition to the electrolyte ions, the electrolyte solution may comprise other compounds including, but not limited to, ionic compounds such as negatively-charged agents to enhance electrolyte conductivity, buffer compounds to stabilize electrolyte pH, and different additives. Examples of natively-charged agents, include but are not limited to, bromide (BO, carbonate (CO₃⁻), hydrogen carbonate (HCO₃⁻), chlorate (ClO₃⁻), chromate (CrO₄⁻), cyanide (CN⁻), dichromate (Cr₂O₇²⁻), dihydrogenphosphate (H₂PO₄⁻), fluoride (F), hydride (H⁻), hydrogen phosphate (HP0₄²⁻), hydrogen sulfate or bisulfate (HSO₄⁻), hydroxide (OH⁻), iodide (I⁻), nitride (N³⁻), nitrate (NO₃⁻), nitrite (NO₂⁻), oxide (O₂⁻), permanganate (MnO₄⁻), peroxide (O₂²⁻), phosphate (PO₄³⁻), sulfide (S²⁻), thiocyanate (SCN⁻), sulfite (SO₃²⁻), sulfate (SO₄²⁻), chloride (Cl⁻), boride (B³⁻), borate (BO₃³⁻), disulfide (S₂²⁻), phosphanide (PH₂⁻), phosphanediide (PH²⁻), superoxide (O₂⁻), ozonide (O₃⁻), triiodide (I₃⁻), dichloride (Cl₂⁻), dicarbide (C₂²⁻), azide (N₃⁻), pentastannide (Sn₅²⁻), nonaplumbide (Pb₉⁴⁻), azanide or dihydridonitrate (NH₂⁻), germanide (GeH₃⁻), sulfanide (HS⁻), sulfanuide (H₂S⁻), hypochlorite (ClO⁻), hexafluoridophosphate ([PF₆]⁻), tetrachloridocuprate(II) ([Cl₄]²⁻), tetracarbonylferrate ([Fe(CO)₄]²⁻), hydrogen(nonadecaoxidohexamolybdate) (HMo₆O₁₉⁻), tetrafluoroborate ([BF₄]⁻), Bis(trifluoromethylsulfonyl)imide ([NTf₂]⁻), trifluoromethanesulfonate ([TfO]⁻), Dicyanamide [N(CN)₂]⁻, methylsulfate [MeSO₄]⁻, dimethylphosphate [Me₂PO₄]⁻, acetate [MeCO₂]⁻, other similar groups, or any combination thereof.

In addition to the positively- and negatively charged agents, respectively, the electrolyte solution can also comprise one or several additives. Illustrative examples of additives, include are but not limited to, thiourea, acetone, ethanol, cadmium ion, chloride ion, stearic acid, ethylenediamine dihydrochloride, saccharin, cetyltrimethylammonium bromide (CTAB), sodium dodecyl sulfate, ethyl vanillin, ammonia, ethylene diamine, polyethylene glycol (PEG), bis(3-sulfopropyl)disulfide (SPS), Janus green B (JGB), azobenzene-based surfactant (AZTAB), the polyoxyethylene family of surface active agents, sodium citrate, perfluorinated alkylsulfate, additive K, calcium chloride, ammonium chloride, potassium chloride, boric acid, myristic acid, choline chloride, citric acid, any redox active surfactant, any conductive ionic liquids, any wetting agents, any leveling agent, any defoaming agent, any emulsifying agent or any combination thereof. Examples of wetting agents include, but are not limited, to polyglycol ethers, polyglycol alcohols, sulfonated oleic acid derivatives, sulfate form of primary alcohols, alkylsulfonates, alkylsulfates aralkylsulfonates, sulfates, Perfluoro-alkylsulfonates, acid alkyl and aralkyl-phosphoric acid esters, alkylpolyglycol ether, alkylpolyglycol phosphoric acid esters or their salts, or any combination thereof. Examples of leveling agents include, but are not limited to, N-containing and optionally substituted and/or quaternized polymers, such as polyethylene imine and its derivatives, polyglycine, poly(allylamine), polyaniline (sulfonated), polyvinylpyrrolidone, polyvinylpyridine, polyvinylimidazole, polyurea, polyacrylamide, poly(melamine-co-formaldehyde), polyalkanolamines, polyaminoamide and derivatives thereof, polyalkanolamine and derivatives thereof, polyethylene imine and derivatives thereof, quaternized polyethylene imine, poly(allylamine), polyaniline, polyurea, polyacrylamide, poly(melamine-co-formaldehyde), reaction products of amines with epichlorohydrin, reaction products of an amine, epichlorohydrin, and polyalkylene oxide, reaction products of an amine with a polyepoxide, polyvinylpyridine, polyvinylimidazole, polyvinylpyrrolidone, or copolymers thereof, nigrosines, pentamethyl-para-rosaniline, or any combination thereof. Examples of defoaming agents include, but are not limited to, fats, oils, long chained alcohols or glycols, alkylphosphates, metal soaps, special silicone defoamers, commercial perfluoroalkyl-modified hydrocarbon defoamers and perfluoroalkyl-substituted silicones, fully fluorinated alkylphosphonates, perfluoroalkyl-substituted phosphoric acid esters, or any combination thereof. Examples of emulsifying agents include, but are not limited to, cationic-based agents such as the alkyl tertiary heterocyclic amines and alkyl imadazolinium salts, amphoteric-based agents such as the alkyl imidazoline carboxylates, and nonionic-based agents such as the aliphatic alcohol ethylene oxide condensates, sorbitan alkyl ester ethylene oxide condensates, and alkyl phenol ethylene oxide condensates.

In some instances, the electrolyte mixture may also comprise a pH adjusting agent selected from a group including but not limited to inorganic acids, ammonium bases, phosphonium bases, or any combination thereof. The pH of the electrolyte mixture can be adjusted to a value within the range of 3 to 10 using these pH adjusting agents. The electrolyte can also include nanoparticles that can get entrapped in the textured coating. Examples of nanoparticles include, but are not limited to, PTFE particles, silica (SiO₂) particles, alumina particles (Al₂O₃), silicon carbide (SiC), diatomaceous earth (DE), boron nitride (BN), titanium oxide (TiO₂), diamond, particles formed from differential etching of spinodally decomposed glass, single wall carbon nanotubes (SWCNTs), multi-wall carbon nanotubes (MWCNTs), platinum oxide (PtO₂), other nanoparticles, any chemically or physically modified versions of the foregoing particles, or any combination thereof. As noted herein, the electrodeposition process can be used to co-deposit a metal or metallic compound in combination with a hydrophobic or repellent material which becomes integral or part of the deposited texture coating. As a non-limiting example, a textured copper layer can be electrodeposited from an aqueous solution comprising Cu²⁺, SO₄²⁻, H⁺, other charged agents, or additives. As another non-limiting example, a textured zinc layer can be electrodeposited from an aqueous solution comprising Zn²⁺, Cl⁻, BO₃³⁻, H⁺, K⁺, other charged agents, or additives.

In certain examples, the substrate or the base article of the coating can be a part of cathode 204. In FIG. 2, the substrate 204 is schematically depicted as a square box; however, it can have different shapes. As an instance, the substrate can be a part of a tube or an object with any regular or irregular geometry. The substrate can be made of any material that may be electroplated including metals, alloys, plastics, composites, and ceramics. In some examples, the substrate may be a non-anodizable substrate, steel, steel alloys, steel comprising different grades of carbon steel or stainless steel. In other examples, an intermediate layer can be applied between the substrate and the electrodeposited textured coating. The substrate can be conductive or non-conductive. However, for non-conductive substrates an intermediate activation layer or seed layer may be applied before the electrodeposition process.

In some embodiments, in a two-electrode electrodeposition process, such as that depicted in FIG. 2, the anode 206 is the reference of the voltage. It is also possible to provide a third electrode as a voltage reference. In addition, the anode 206 may take various shapes and forms as desired. As an instance, it can be in the shape of pallets, mesh, bar, cylinder or it can be a part of an object with any regular or irregular geometry. The anode 206 can gradually dissolve during the electrodeposition process and contribute in replenishing the positively charged-ions in the electrolyte. As a non-limiting example, zinc and nickel plates can be used in the zinc and nickel electrodeposition process, respectively. Some anodes such as those made of platinum or titanium remain intact during the electrodeposition process.

In certain examples and while not wishing to be bound by any particular theory, the formation of the textured coating by electrodeposition can be understood from the following non-limiting explanation. The electroplating process is based on a nucleation and growth mechanism. Non-homogeneous conditions during the nucleation and growth process can result in the formation of textures on the surface of the growing material layer. When the conditions of the growth are not homogeneous, different locations of the surface encounter different growth rates. Some locations grow faster and form peaks while others grow slower and become valleys. This presence of these different resulting features provide for a surface texture on the substrate. In electroplating, different parameters such as voltage, bath composition, agitation, and bath temperature can be adjusted to control the level of non-homogeneity in the nucleation and growth process, and therefore, make different surface textures. In some instances, the electroplating conditions can be altered during textured coating formation to promote the formation of the microstructures of the textured coating. The effects of the process parameters on the deposited textured coating can be better understood by the following non-limiting explanation on the effects of voltage and bath composition. In some examples, the applied voltage can be controlled or tuned during coating to promote formation of the microstructures. The effect of the applied voltage can be explained by unstable growth theories such as Mullins-Sekerka instability model (see, for example, Mullins and Sekerka, Journal of Applied Physics, Volume 35, Issue 2 (2004). Based on these theories, diffusional mass transfer favors the growth of the arbitrary protrusions of the surface and enhances the morphological instabilities or texture of the growing surface. The effect of the diffusional mass transfer on the formation and enhancement of surface texture can be explained by reference to protrusions formed on a growing surface. A protrusion has a smaller height than the diffusion layer thickness and falls completely inside the diffusion layer. A tip of this protrusion falls into the spherical diffusion regime while other parts of the surface are still under the linear diffusion regime. Since the rate of the spherical diffusion is greater than the rate of linear diffusion, the protrusion grows faster than the other parts of the surface. When the protrusion becomes large enough, smaller protrusions grow on top of that. The diffusion at the tip of these smaller protrusions is faster than the primary protrusion. This irregular growth can lead to other consecutive layers of smaller protrusions and may result in the formation of a hierarchical structure. By controlling the applied voltage, desired growth rates and effects for the surface textures can be achieved.

In certain configurations, similar to the applied voltage, the concentration of different species on the electrolyte can also affect the level of diffusional mass transfer in the bath and, therefore, can have an effect on the deposited texture coating. In addition to this effect, bath composition can have other interesting effects on the deposit texture coating, which is called the additive effect. The additive effect refers to the effect of a chemical reagent on making non-homogeneous growth conditions and subsequently forming a surface texture. Different chemical reagents undergo different mechanisms to promote the non-homogeneous growth condition. For example, additive reagent can restrict growth in specific directions and results in a non-homogeneous growth process and texture formation. Additives which restrict the growth process in the horizontal direction and result in the formation of conical structures are referred to as crystal modifiers. Crystal modifiers kinetically control the growth rates of different crystalline faces of metal particles by interacting with these faces through adsorption and desorption. Coordinating reagents are another group of additives that can promote non-homogeneous growth conditions and form surface textures. These additives form complexes with some of the metal ions. The other ions remain free in the solution. The presence of two different types of metal ions (free ions and ions involved in complexation) results in a non-homogeneous growth condition and can promote texture formation.

In certain examples, the exact attributes and properties of the textured coatings described herein can vary depending on the particular materials which are present, the coating conditions used, etc. In some examples, the microstructures of the textured coating may exhibit a hierarchical structure. Hierarchical structure refers to the condition where each surface feature comprises smaller individual features. For example, the size of features in hierarchical structures can desirably be at least two times larger than their constituent features. As a prophetic example, the first feature size might be 10 microns while the second feature size is 1 micron.

In certain instances, the textured coating can comprise a composite of metals or metallic compound and nanoparticles. Nanoparticles can be selected from the group consisting of PTFE particles, silica (SiO₂) particles, alumina particles (Al₂O₃), silicon carbide (SiC), diatomaceous earth (DE), boron nitride (BN), titanium oxide (TiO₂), platinum oxide (PtO₂), diamond, particles formed from differential etching of spinodally decomposed glass, single wall carbon nanotubes (SWCNTs), mix silicon/titanium oxide particles (TiO₂/SiO₂, titanium inner core/silicon outer surface), ceramic particles, thermo-chromic metal oxide, multi-wall carbon nanotubes (MWCNTs), any chemically or physically modified versions of the foregoing particles, and any combinations thereof.

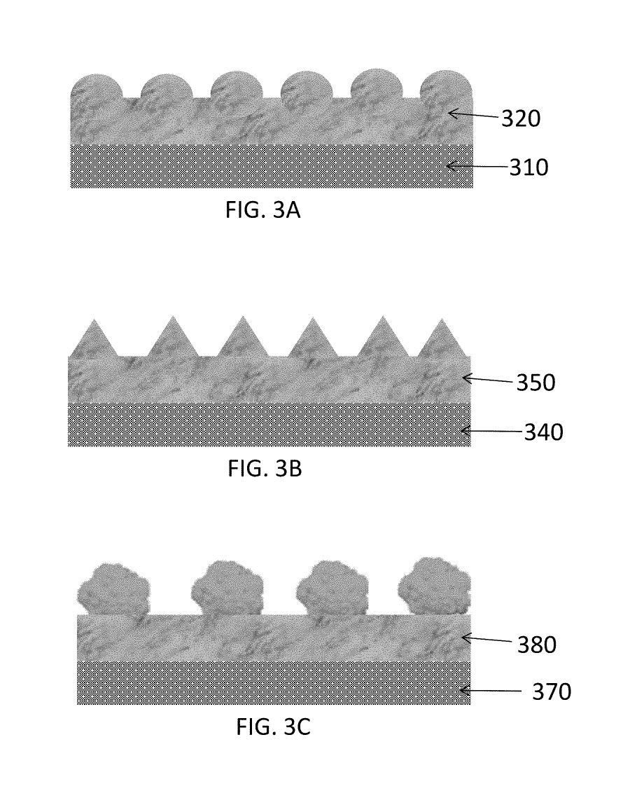

In certain embodiments and as described in more detail below, at least one region of the textured coating comprises a plurality of microscale features or microstructures with different or similar shapes. As used herein, “microscale features” refer to features with at least one dimension in micro or nano size range, e.g., comprising an average diameter from a few hundred nanometers up to about 100-250 microns. Illustrations of microstructures are shown in FIGS. 3A, 3B and 3C. For example and referring to FIG. 3A, a textured coating 320 on a substrate 310 comprises regular circular shaped microstructures. In FIG. 3B, a textured coating 350 on a substrate 340 comprises regular triangular or pyramidal shaped microstructures. In FIG. 3C, a textured coating 380 on a substrate 370 comprises irregular spherical shaped microstructures. Without wishing to be bound by any particular scientific theory, the mass of the regular geometries is directly proportional to their characteristic dimension raised to an integer power (e.g. a third power for a sphere). In another instance, microscale surface features have irregular geometries such as fractals. The mass of irregular geometries is directly proportional to their characteristic dimension raised to a fractional power. As noted herein, these microstructures may comprise a first size, e.g., an average characteristic length, which can be used in combination with a surface coating to enhance adhesion of the surface coating in the article. In some examples, an average particle size of the surface coating material is selected to be less than the first size, e.g., the average characteristic length, of the microstructures to permit the surface coating to infuse into, penetrate or grip the various microstructures of the textured layer and/or to enter into any space or spaces between them or in them.

In some examples, the textured coating may comprise at least one metal or metallic compound. In certain configurations, the textured coating provides a hydrophobic surface/coating comprising a plurality of individual microstructures on the surface of the substrate. As noted herein, the size of the surface features of the textured coating can be defined based on their largest characteristic length. Some textured coatings comprise, for example, surface features in the range of 5 to 15 micrometers. Others textured coatings may comprise surface features in the range of 0.5 to 1 micrometer. The exact size of the microstructures may be selected or tuned based on the average particle size of the surface coating material to be disposed with the average particle size of the surface coating material generally being less than that of the size of the textured coating microstructures. In some examples, the surface features of the textured coating are positioned within at least at two different surface planes with different heights in regard to an arbitrary zero reference point. In other instances, the features of the textured coating can be packed closely together with negligible, e.g., substantially no space or no space between adjacent features compared to the overall size of the features. Even though the microstructures of the textured coating can be tightly packed, they may remain porous enough to permit gripping of the material of the surface coating to enhance adhesion of the surface coating.

In some examples, as discussed above, this size or first size of the microstructures refers to the largest characteristic length of the surface features. Where the microstructures are generally spherically shaped, the largest diameters of these spheres can be defined as the first size of the surface features. The surface features of the textured coating can be desirably positioned at least at two different surface planes with different heights in regard to an arbitrary zero point. While not wishing to be bound by this example, there can be negligible space between adjacent surface features compared to the size of the features. After coating of the textured coating with the surface coating, substantially no open space may exist between the microstructures. This filling of gaps and voids by the surface coating can reduce overall surface roughness, e.g., by 50% or more, and may result in a decrease in the overall porosity of the textured coating to be close to zero, e.g., less than 5%, 4$ %, 3%, 2%, or 1%.

In certain examples, the textured coatings described herein may comprise at least one metal or metallic compound. Examples of some of the metals which can be used include, but are not limited, to nickel (Ni), zinc (Zn), chromium (Cr), copper (Cu), zinc/nickel (Zn/Ni) alloys, zinc/copper (Zn/Cu) alloy, chromium alloys and other transition metals and combinations thereof. Examples of metallic compounds include, but are not limited to, metal oxides, metal carbides, metal nitrides, metal hydroxides, metal carbonitrides, metal oxynitrides, metal borides, metal borocarbides, metal fluorides, other metal compounds, or any combination thereof. Energy-dispersive (EDS) X-ray spectroscopy or any other analytical techniques can be used to show the presence of metal or metallic compound in the textured coating. Further, the textured coating may also comprise repellent or hydrophobic materials co-disposed at the same time as the metal or metallic compounds are disposed on the substrate. In some examples, a metal or metallic compound and a repellent or hydrophobic material may be present in the textured coating and may be co-disposed by including both materials in an electrolyte solution used to provide the textured coating by way of an electrodeposition process.

In certain configurations, the textured coatings described herein may provide hydrophobic characteristics without any additional chemical treatment. If desired, certain physical treatments may be performed post-deposition of the textured coating to enhance the hydrophobicity of the deposited textured coating. For example, a water contact angle of greater than 90° can be provided in the textured coatings described herein. In addition, a superhydrophobic coating is defined as a coating which provides a water contact angle of more than 150°. Water contact angle can be measured using contact angle measurement equipment based on the ASTM D7490-13 standard. This angle is conventionally measured through the droplet, where the water-air interface meets the solid surface. A Kruss-582 system can be used to obtain the contact angle data. In certain examples, the exact properties of the coatings described herein may vary depending on the materials present and the methods used to produce the coatings. Without wishing to be bound by any particular theory, the effect of texture on the hydrophobic properties of a surface can be explained, for example, using the following illustration: as air is trapped in void spaces between microscale and nanoscale structures, the trapped air protects the surface against wetting. Since air is an absolute hydrophobic material, this air trapping results in enhancing the hydrophobic property of the surface and a large contact angle (θ₁) is formed. By using the materials and processes described herein, packing of micro- and nano-structures together to trap air between the tightly packed structures can further enhance hydrophobicity of the coatings. In addition, some amount of this air can be displaced by repellent or hydrophobic particles of the surface coating to further increase hydrophobicity of the coatings of the articles produced herein.

In certain configurations, in addition to the metal or metallic compound of the textured coating, the textured coating can comprise other materials as well. These materials may be present in the textured coating or deposited on top of the textured coating as desired. For example, the textured coating may comprise one or more of Chromium Nitride (CrN), Diamond Like Carbon (DLC), Titanium Nitride (TiN), Titanium Carbo-nitride (TiCN), Aluminum Titanium Nitride (ALTiN), Aluminum Titanium Chromium Nitride (AlTiCrN), Zirconium Nitride (ZrN), Nickel, gold, PlasmaPlus®, Cerablack™, Chromium, Nickel Fluoride (NiF₂), any Nickel Composite, any organic or inorganic-organic material and combinations thereof. Examples of nickel composites include, but are not limited to, composites of nickel with different particles selected from a group consisting of PTFE, silica (SiO₂), alumina (Al₂O₃), silicon carbide (SiC), diamond, diatomaceous earth (DE), boron nitride (BN), titanium oxide (TiO2), single wall carbon nanotubes (SWCNTs), multi-wall carbon nanotubes (MWCNTs), kaoline (Al₂O₃.2SiO₂.2H₂O), graphite, other nanoparticles, or any combination thereof. Examples of organic or inorganic-organic materials include, but are not limited to, parylene, organofunctional silanes, fluorinated alkylsilane, fluorinated alkylsiloxane, organofunctional resins, hybrid inorganic organofunctional resins, organofunctional polyhedral oligomeric silsesquioxane (POSS), hybrid inorganic organofunctional POSS resins, silicone polymers, fluorinated oligomeric polysiloxane, organofunctional oligomeric poly siloxane, fluorinated organofunctional silicone copolymers, organofunctional silicone polymers, hybrid inorganic organofunctional silicone polymers, organofunctional silicone copolymers, hybrid inorganic organofunctional silicone copolymers, fluorinated polyhedral oligomeric silsesquioxane (FPOSS), Dynasylan® SIVO, other similar groups, or any combination thereof.

In some instances, organofunctional silanes are a group of compounds that combine the functionality of a reactive organic group with inorganic functionality in a single molecule. This special property allows them to be used as molecular bridges between organic polymers and inorganic materials. The organic moiety of the silane system can be tailored with different functionalities consisting amino, benzylamino, benzyl, chloro, fluorinated alkyl/aryl, disulfido, epoxy, epoxy/melamine, mercapto, methacrylate, tetrasulfido, ureido, vinyl, vinyl-benzyl-amino, and any combination thereof. While any of these groups can be used application of the following groups is more common: amino, chloro, fluorinated alkyl/aryl, vinyl, and vinyl-benzyl-amino. The examples of aminosilane system are n-(3-acryloxy-2-hydroxypropyl)-3-aminopropyltriethoxysilane, n-(n-acetylleucyl)-3-aminopropyltriethoxysilane, 3-(n-allylamino)propyltrimethoxysilane, 4-aminobutyltriethoxysilane, 4-amino-3,3-dimethylbutylmethyldimethoxysilane, 4-amino-3,3-dimethylbutyltrimethoxysilane, aminoneohexyltrimethoxysilane, 1-amino-2-(dimethylethoxysilyl)propane, n-(2-aminoethyl)-3-aminoisobutyldimethylmethoxysilane, n-(2-aminoethyl)-3-aminoisobutylmethyldimethoxysilane, (aminoethylaminomethyl)phenethyltrimethoxysilane, n-(2-aminoethyl)-3-aminopropylmethyldiethoxysilane, n-(2-aminoethyl)-3-aminopropylmethyldimethoxysilane, n-(2-aminoethyl)-3-aminopropyltrimethoxysilane-propyltrimethoxysilane, oligomeric co-hydrolysate, n-(2-aminoethyl)-2,2,4-trimethyl-1-aza-2-silacyclopentane, n-(6-aminohexyl)aminomethyltriethoxysilane, n-(2-aminoethyl)-11-aminoundecyltrimethoxysilane, 3-(m-aminophenoxy)propyltrimethoxysilane, m-aminophenyltrimethoxysilane, p-aminophenyltrimethoxysilane, aminophenyltrimethoxysilane, n-3-[amino(polypropylenoxy)]aminopropyltrimethoxysilane, 3-aminopropyldiisopropylethoxysilane, 3-aminopropyldiisopropylethoxysilane, 3-aminopropyldimethylethoxysilane, 3-aminopropyldimethylfluorosila, n-(3-aminopropyldimethylsilyl)aza-2,2-dimethyl-2-silacyclopentane, 3-aminopropylmethyldiethoxysilane, 3-aminopropyltris(methoxyethoxyethoxy)silane, 11-aminoundecyltriethoxysilane, n-(2-n-benzylaminoethyl)-3-aminopropyltrimethoxysilane, n,n-bis(2-hydroxyethyl)-3-aminopropyltriethoxysilane, bis(trimethylsilyl)-3-aminopropyltrimethoxysilane, n-butylaminopropyltrimethoxysilane, t-butylaminopropyltrimethoxysilane, (n-cyclohexylaminomethyl) methyldiethoxysilane, (n-cyclohexylaminopropyl) trimethoxysilane, (n,n-diethylaminomethyl)triethoxysilane, (n,n-diethyl-3-aminopropyl)trimethoxysilane, 3-(n,n-dimethylaminopropyl)aminopropylmethyldimethoxysilane, (n,n-dimethylaminopropyl)-aza-2-methyl-2-methoxysilacyclopentane, n,n-dimethyl-3-aminopropylmethyldimethoxysilane, 3-(1,3-dimethylbutylidene)aminopropyltriethoxysilane, (3-(n-ethylamino)isobutyl)methyldiethoxysilane, (3-(n-ethylamino)isobutyl)trimethoxysilane, n-methyl-n-trimethylsilyl-3-aminopropyltrimethoxysilane, (phenylaminomethyl)methyldimethoxysilane, n-phenylaminomethyltriethoxysilane, n-phenylaminopropyltrimethoxysilane, 3-(n-styrylmethyl-2-aminoethylamino)propyltrimethoxysilane hydrochloride, (3-trimethoxysilylpropyl)diethylenetriamine, (cyclohexylaminomethyl)triethoxy-silane, (n-methylaminopropyl)methyl(1,2-propanediolato)silane, n-(trimethoxysilylpropyl)ethylenediaminetriacetate, tripotassium salt, n-(trimethoxysilylpropyl)ethylenediaminetriacetate, trisodium salt, 1-[3-(2-aminoethyl)-3-aminoisobutyl]-1,1,3,3,3-pentaethoxy-1,3-disilapropane, bis(methyldiethoxysilylpropyl)amine, bis(methyldimethoxysilylpropyl)-n-methylamine, bis(3-triethoxysilylpropyl)amine, n,n′-bis[(3-trimethoxysilyl)propyl]ethylenediamine, tris(triethoxysilylpropyl)amine, tris(triethoxysilylmethyl)amine, bis [4-(triethoxysilyl)butyl]amine, tris [(3-diethoxymethylsilyl)propyl)amine, n-(hydroxyethyl)-n,n-bis(trimethoxysilylpropyl)amine, n-(hydroxyethyl)-n-methylaminopropyltrimethoxysilane, n-(3-methacryloxy-2-hydroxypropyl)-3-aminopropyltriethoxysilane, 3-(n-styrylmethyl-2-aminoethylamino)propyltrimethoxysilane, 3-(2,4-dinitrophenylamino)propyltriethoxysilane, 4-nitro-4(n-ethyl-n-trimethoxysilylcarbamato)aminoazobenzene, bis(diethylamino)dimethylsilane, bis(dimethylamino)diethylsilane, bis(dimethylamino)dimethylsilane, (diethylamino)trimethylsilane, (n,n-dimethylamino)trimethylsilane, tris(dimethylamino)methylsilane, n-butyldimethyl(dimethylamino)silane, n-decyltris(dimethylamino)silane, n-octadecyldiisobutyl(dimethylamino)silane, n-octadecyldimethyl(diethylamino)silane, n-octadecyldimethyl(dimethylamino)silane, n-octadecyltris(dimethylamino)silane, n-octyldiisopropyl(dimethylamino) silane, n-octyldimethyl(dimethylamino)silane, and any combination thereof. The examples of the benzylaminosilane system are n-(2-n-benzylaminoethyl)-3-aminopropyltrimethoxysilane, n-(2-n-benzylaminoethyl)-3-aminopropyltrimethoxysilane hydrochloride, n-benzylaminomethyltrimethylsilane, or any combination thereof. The example of benzylsilane system are benzyldimethylchlorosilane, benzyldimethylsilane, n-benzyl-n-methoxymethyl-n-(trimethylsilylmethyl) amine, benzyloxytrimethylsilane, benzyltrichlorosilane, benzyltriethoxysilane, benzyltrimethylsilane, bis(trimethylsilylmethyl)benzylamine, (4-bromobenzyl) trimethylsilane, dibenzyloxydiacetoxysilane, or any combination thereof. The examples of chloro and chlorosilane system are (−)-camphanyldimethylchlorosilane, 10-(carbomethoxy)decyldimethylchlorosilane, 10-(carbomethoxy)decyltrichlorosilane, 2-(carbomethoxy)ethylmethyldichlorosilane, 2-(carbomethoxy)ethyltrichlorosilane, 3-chloro-n,n-bis(trimethylsilyl) aniline, 4-chlorobutyldimethylchlorosilane, (chlorodimethylsilyl)-5-[2-(chlorodimethylsilyl)ethyl]bicycloheptane, 13-(chlorodimethylsilylmethyl)heptacosane, 11-(chlorodimethylsilyl)methyltrico sane, 7-[3-(chlorodimethylsilyl)propoxy]-4-methylcoumarin, 2-chloroethylmethyldichlorosilane, 2-chloroethylmethyldimethoxysilane, 2-chloroethylsilane, 1-chloroethyltrichlorosilane, 2-chloroethyltrichlorosilane, 2-chloroethyltriethoxysilane, 1-chloroethyltrimethylsilane, 3-chloroisobutyldimethylchlorosilane, 3-chloroisobutyldimethylmethoxysilane, 3-chloroisobutylmethyldichlorosilane, 1-(3-chloroisobutyl)-1,1,3,3,3-pentachloro-1,3-disilapropane, 1-(3-chloroisobutyl)-1,1,3,3,3-pentaethoxy-1,3-disilapropane, 3-chloroisobutyltrimethoxysilane, 2-(chloromethyl)allyltrichlorosilane, 2-(chloromethyl)allyltrimethoxysilane, 3-[2-(4-chloromethylbenzyloxy)ethoxy]propyltrichlorosilane, chloromethyldimethylchlorosilane, chloromethyldimethylethoxysilane, chloromethyldimethylisopropoxysilane, chloromethyldimethylmethoxysilane, (chloromethyl)dimethylphenylsilane, chloromethyldimethylsilane, 3-(chloromethyl)heptamethyltrisiloxane, chloromethylmethyldichlorosilane, chloromethylmethyldiethoxysilane, chloromethylmethyldiisopropoxysilane, chloromethylmethyldimethoxysilane, chloromethylpentamethyldisiloxane, ((chloromethyl)phenylethyl)dimethylchlorosilane, ((chloromethyl)phenylethyl)methyldichlorosilane, ((chloromethyl)phenylethyl)methyldimethoxysilane, ((chloromethyl)phenylethyl)trichlorosilane, ((chloromethyl)phenylethyl)triethoxysilane, ((chloromethyl)phenylethyl)trimethoxysilane, chloromethylphenethyltris(trimethylsiloxy)silane, (p-chloromethyl)phenyltrichlorosilane, (p-chloromethyl)phenyltrimethoxysilane, chloromethylsilatrane, chloromethyltrichlorosilane, chloromethyltriethoxysilane, chloromethyltriisopropoxysilane, chloromethyltrimethoxysilane, chloromethyltrimethylsilane, 2-chloromethyl-3-trimethylsilyll-propene, chloromethyltris(trimethylsiloxy) silane, (5-chloro-1-pentynyl)trimethylsilane, chlorophenylmethyldichloro-silane , chlorophenyltrichlorosilane, chlorophenyltriethoxysilane, p-chlorophenyltriethoxysilane, p-chlorophenyltrimethylsilane, (3-chloropropoxy)isopropyldimethylsilane, (3-chloropropyl)(t-butoxy)dimethoxysilane, 3-chloropropyldimethylchlorosilane, 3-chloropropyldimethylethoxysilane, 3-chloropropyldimethylmethoxysilane, 3-chloropropyldimethylsilane, 3-chloropropyldiphenylmethylsilane, chloropropylmethyldichloro silane, 3-chloropropylmethyldiethoxysilane, 3-chloropropylmethyldiisopropoxysilane, 3-chloropropylmethyldimethoxysilane, (3-chloropropyl)pentamethyldisiloxane, 3-chloropropyltrichlorosilane, 3-chloropropyltriethoxysilane, 3-chloropropyltrimethoxysilane, 3-chloropropyltrimethylsilane, 3-chloropropyltriphenoxysilane, 3-chloropropyltris(trimethylsiloxy)silane, 2-(4-chlorosulfonylphenyl)ethyltrichlorosilane, 2-(4-chlorosulfonylphenyl)ethyltrichlorosilane, 2-(4-chlorosulfonylphenyl)ethyltrimethoxysilane, 2-(4-chlorosulfonylphenyl)ethyltrimethoxysilane, 1-chloro-5-(trimethylsilyl)-4-pentyne, chlorotris(trimethylsilyl)silane, 11-chloroundecyltrichlorosilane, 11-chloroundecyltriethoxysilane, 11-chloroundecyltrimethoxysilane, 1-chlorovinyltrimethylsilane, (3-cyanobutyl)dimethylchlorosilane, (3-cyanobutyl)methyldichlorosilane, (3-cyanobutyl)trichlorosilane, 12-cyanododec-10-enyltrichlorosilane, 2-cyanoethylmethyldichlorosilane, 2-cyanoethyltrichlorosilane, 3-cyanopropyldiisopropylchlorosilane, 3-cyanopropyldimethylchlorosilane, 3-cyanopropylmethyldichlorosilane, 3-cyanopropylphenyldichlorosilane, 3-cyanopropyltrichlorosilane, 3-cyanopropyltriethoxysilane, 11-cyanoundecyltrichlorosilane, [2-(3-cyclohexenyl)ethyl]dimethylchlorosilane, [2-(3-cyclohexenyl)ethyl]methyldichlorosilane, [2-(3-cyclohexenyl)ethyl]trichlorosilane, 3-cyclohexenyltrichlorosilane, cyclohexyldimethylchlorosilane, cyclohexylmethyldichlorosilane, (cyclohexylmethyl)trichlorosilane, cyclohexyltrichlorosilane, (4-cyclooctenyl)trichlorosilane, cyclooctyltrichlorosilane, cyclopentamethylenedichlorosilane, cyclopentyltrichlorosilane, cyclotetramethylenedichlorosilane, cyclotrimethylenedichlorosilane, cyclotrimethylenemethylchlorosilane, 1,3-dichlorotetramethyldisiloxane, 1,3-dichlorotetraphenyldisiloxane, dicyclohexyldichlorosilane, dicyclopentyldichlorosilane, di-n-dodecyldichlorosilane, dodecylmethylsilyl)methyldichlorosilane, diethoxydichlorosilane, or any combination thereof. The examples of the epoxysilane system are 2-(3,4-epoxycyclohexyl) ethylmethyldiethoxysilane, 2-(3,4-epoxycyclohexyl) ethyltriethoxysilane, 2-(3,4-epoxycyclohexyl) ethyltrimethoxysilane, 5,6-epoxyhexyltriethoxysilane, (epoxypropyl)heptaisobutyl-T8-silsesquioxane, or any combination thereof. The example of mercaptosilane system are (mercaptomethyl)methyldiethoxysilan, 3-mercaptopropylmethyldimethoxysilane, 3-mercaptopropyltriethoxysilane, 3-mercaptopropyltrimethoxysilane, 3-mercaptopropyltrimethoxysilane, 3-mercaptopropyltrimethylsilane, 3-mercaptopropyltriphenoxysilane, 11-mercaptoundecyloxytrimethylsilane, 11-mercaptoundecyltrimethoxysilane, or any combination thereof. The examples of ureidosilane are ureidopropyltriethoxysilane, ureidopropyltrimethoxysilane, or any combination thereof. The examples of vinyl, vinylbenzylsilane system are vinyl(bromomethyl)dimethylsilane, (m,p-vinylbenzyloxy)trimethylsilane, vinyl-t-butyldimethylsilane, vinyl(chloromethyl)dimethoxysilane, vinyl(chloromethyl)dimethylsilane, 1-vinyl-3-(chloromethyl)-1,1,3,3-tetramethyldisiloxane, vinyldiethylmethylsilane, vinyldimethylchlorosilane, vinyldimethylethoxysilane, vinyldimethylfluorosilane, vinyldimethylsilane, vinyldi-n-octylmethylsilane, vinyldiphenylchlorosilane, vinyldiphenylethoxysilane, vinyldiphenylmethylsilane, vinyl(diphenylphosphinoethyl)dimethylsilane, vinyl(p-methoxyphenyl)dimethylsilane, vinylmethylbis(methylethylketoximino)silane, vinylmethylbis(methylisobutylketoximino)silane, vinylmethylbis(trimethylsiloxy)silane, vinylmethyldiacetoxysilane, vinylmethyldichlorosilane, vinylmethyldichlorosilane, vinylmethyldiethoxysilane, vinylmethyldimethoxysilane, 1-vinyl-1-methylsilacyclopentane, vinyloctyldichlorosilane, o-(vinyloxybutyl)-n-triethoxysilylpropyl carbamate, vinyloxytrimethylsilane, vinylpentamethyldisiloxane, vinylphenyldichlorosilane, vinylphenyldiethoxysilane, vinylphenyldimethylsilane, vinylphenylmethylchlorosilane, vinylphenylmethylmethoxysilane, vinylphenylmethylsilane, vinylsilatrane, vinyl-1,1,3,3-tetramethyldisiloxane, vinyltriacetoxysilane, vinyltri-t-butoxysilane, vinyltriethoxysilane, vinyltriethoxysilane, oligomeric hydrolysate, vinyltriethoxysilane-propyltriethoxysilane, oligomeric co-hydrolysate, vinyltriethylsilane, vinyl(trifluoromethyl)dimethylsilane, vinyl(3,3,3-trifluoropropyl)dimethylsilane, vinyltriisopropenoxysilane, vinyltriisopropoxysilane, vinyltrimethoxysilane, vinyltrimethoxysilane, oligomeric hydrolysate, vinyltrimethylsilane, vinyltriphenoxysilane, vinyltriphenylsilane, vinyltris(dimethylsiloxy)silane, vinyltris(2-methoxyethoxy)silane, vinyltris(1-methoxy-2-propoxy)silane, vinyltris(methylethylketoximino)silane, vinyltris(trimethylsiloxy)silane, or any combination thereof.

Illustrative examples of fluorinated alkyl/aryl silane include, but are not limited to, 4-fluorobenzyltrimethylsilane, (9-fluorenyl) methyldichlorosilane, (9-fluorenyl) trichlorosilane, 4-fluorophenyltrimethylsilane, 1,3-bis(tridecafluoro-1,1,2,2-tetrahydrooctyl) tetramethyldisiloxane, 1H,1H,2H,2H-perfluorodecyltrimethoxysilane, 1H,1H,2H,2H-perfluorodecyltrichlorosilane, 1H,1H,2H,2H-perfluorooctyltrichlorosilane, 1H,1H,2H,2H-perfluorooctadecyltrichlorosilane, 1H,1H,2H,2H-Perfluorooctyltriethoxysilane, 1H,1H,2H,2H-Perfluorododecyltrichlorosilane, Trimethoxy(3,3,3-trifluoropropyl)silane, tridecafluoro-1,1,2,2-tetrahydrooctyl-1-trimethoxysilane, tridecafluoro-1,1,2,2-tetrahydrooctyl-1-triethoxysilane, and any combination thereof.

In embodiments where an organofunctional resin is present, the organofunctional resin can be selected from the group consisting of epoxy, epoxy putty, ethylene-vinyl acetate, phenol formaldehyde resin, polyamide, polyester resins, polyethylene resin, polypropylene, polysulfides, polyurethane, polyvinyl acetate, polyvinyl alcohol, polyvinyl chloride (PVC), polyvinyl chloride emulsion (PVCE), polyvinylpyrrolidone, rubber cement, silicones, and any combination thereof. Organofunctional polyhedral oligomeric silsesquioxane (POSS) can be selected from the group consisting acrylates, alcohols, amines, carboxylic acids, epoxides, fluoroalkyls, halides, imides, methacrylates, molecular silicas, norbornenyls, olefins, polyethylenglycols (PEGs), silanes, silanols, thiols, and any combination thereof. Illustrative examples of acrylates POSS's include acryloisobutyl POSS, or any combination thereof. Illustrative examples of alcohols POSS are diol isobutyl POSS, Cyclohexanediol isobutyl POSS, Propanediol isobutyl POSS, Octa (3-hydroxy-3-methylbutyldimethylsiloxy) POSS, or any combination thereof. Illustrative examples of amines POSS are Aminopropylisobutyl POSS, Aminopropylisooctyl POSS, Aminoethylaminopropylisobutyl POSS, OctaAmmonium POSS, Aminophenylisobutyl POSS, Phenylaminopropyl POSS Cage Mixture, or any combination thereof. Illustrative examples of a Carboxylic Acids POSS are Maleamic Acid-Isobutyl POSS, OctaMaleamic Acid POSS, or any combination thereof. Illustrative examples of an epoxide are Epoxycyclohexylisobutyl POSS, Epoxycyclohexyl POSS Cage Mixture, Glycidyl POSS Cage Mixture, Glycidylisobutyl POSS, Triglycidylisobutyl POSS, Epoxycyclohexyl dimethylsilyl POSS, OctaGlycidyldimethylsilyl POSS, or any combination thereof. In the case of fluoroalkyl POSS examples are Trifluoropropyl POSS Cage Mixture, Trifluoropropylisobutyl POSS, or any combination thereof. In the case of halid POSS is Chloropropylisobutyl POSS, or any combination thereof. In the case of Imides POSS examples are POSS Maleimide Isobutyl, or any combination thereof. In the case of Methacrylates examples are Methacryloisobutyl POSS, Methacrylate Ethyl POSS, Methacrylate Isooctyl POSS, Methacryl POSS Cage Mixture, or any combination thereof. In the case of molecular silica POSS examples are DodecaPhenyl POSS, Isooctyl POSS Cage Mixture, Phenylisobutyl POSS, Phenylisooctyl POSS, Octaisobutyl POSS, OctaMethyl POSS, OctaPhenyl POSS, OctaTMA POSS, OctaTrimethylsiloxy POSS, or any combination thereof. In the case of Norbornenyls examples are NB1010-1,3-Bis(Norbornenylethyl)-1,1,3,3-tetramethyldisiloxane, Norbornenylethyldimethylchlorosilane, NorbornenylethylDiSilanolisobutyl POSS, Trisnorbornenylisobutyl POSS, or any combination thereof. In the case of Olefins example are Allyisobutyl POSS, Vinylisobutyl POSS, Vinyl POSS Cage Mixture, or any combination thereof. In the case of PEGs, examples include PEG POSS Cage Mixture, MethoxyPEGisobutyl POSS, or any combination thereof. In the case of a silane examples are OctaSilane POSS, or any combination thereof. In the case of silanols examples are DiSilanolisobutyl POSS, TriSilanolEthyl POSS, TriSilanolisobutyl POSS, TriSilanolisooctyl POSS, TriSilanolPhenyl POSS Lithium Salt, TrisilanolPhenyl POSS, TetraSilanolPhenyl POSS, or any combination thereof. In the case of thiols is Mercaptopropylisobutyl POSS, or any combination thereof.

In certain embodiments, the articles described herein may comprise a surface coating which is generally a repellent or hydrophobic coating of a different composition than that present in the textured coating, though one or more common materials may be present in the textured coating and the surface coating. In conventional repellent coatings, adhesion to different metallic substrates is poor. Adhering repellent coatings to metallic substrates usually requires considerable surface preparation. This preparation process usually includes roughening the metal surface for example by grit blasting. Roughened surfaces are expected to improve adhesion between repellent coatings and the base substrates due to mechanical coupling. However, in some cases the created roughness does not provide enough adhesion. Moreover, for some applications, such as those involved in coating geometrically complex surfaces and hard-to-reach areas, obtaining a properly roughened surface using existing methods such as grit-blasting is either impossible or very difficult. One approach to solve these problems is creating roughness by anodization instead of grit-blasting. However, anodization can just be applied to a few metals and some of the commonly-used metals such as steels or carbon steel cannot be anodized.

Due to these reasons, in spite of great advantages of repellent coatings for some applications, a practical way for applying them on many objects does not exist. For example, new materials and processes that enable successful application of repellent coatings on large and enclosed structures such as oven cavities and cooktops would be desirable. While not wishing to be bound by any specific application, following explanation can be provided for the use of repellent coatings in oven cavities and cooktops. Food residue easily sticks to porcelain enamel coatings, which are used to coat most existing oven cavities and cooktops. Foods are often times spilled upon the surface of oven cavities and cooktops and baked into a hard residue that clings strongly to the enamel coating. The most common technique for removing food residue from oven cavities in residential applications is applying a high temperature cleaning cycle called a “self-cleaning” function. This function applies a high enough temperature for a short time and results in the pyrolysis of the food residue on the surfaces of the oven cavity. “Self-cleaning” function increases energy consumption of the oven. Moreover, its installation adds to the material and manufacturing costs of the oven appliance. Cleaning of cooktops is even more problematic than oven cavities. Consumers usually need to apply a harsh chemical, a sharp cleaning pad, and a large amount of force to remove food residue from the cooktops. This will often scratch and/or damage the cooktop coating. Due to these problems for cleaning food residue from ovens, there is a great interest in replacing porcelain enamel with a repellent coating in various appliances used for heating. Some repellent coatings that have been successfully applied on dishes and cookware do not have required hardness and durability to be applied in ovens. These coatings can be categorized as soft repellent coatings and usually exhibit pencil hardness of less than 6H. Soft coating categories include most fluoropolymer coatings such as Teflon® coatings and Excalibur® coatings. Some of the other ceramic repellent coatings in particular those made by sol-gel processing such as Thermolon™ can provide the required hardness level along with other required characteristics such as FDA approval, high-temperature cleanability and resistance. However, these ceramic coatings also adhere poorly to the carbon steel structures of ovens and cooktops.

If desired, the surface coating may only be present on internal surfaces of the device, e.g., internal surfaces of an oven, heat-exchanger, condenser, piping, tubing, etc. and need not be present on external surfaces of the article. In other examples, substantially all surfaces of the article may comprise a textured coating and/or a surface coating. In some examples, the surface coating can be present on internal surfaces of an article which may contact a material such as food, solvents or the like, and to reduce cost, external surfaces not exposed to the foods, solvents, etc. may not include the surface coating and/or the textured coating.

In some examples, the surface coating present in the articles described herein may comprise one or more polytetrafluoroethylene (PTFE) coatings such as Teflon® coatings, Xylan® coatings, Excalibur® coatings, Sunoloy® coatings, Solvay Solexis Halar® coatings, Wearlon® coatings. In other examples, the surface coating comprises one or more ceramic coatings such as Thermolon™ coatings or Cerakote™ coatings. In additional examples, the surface coating comprises one or more metal based coating such as molybdenum disulfide coatings, e.g., Dow Corning Molykote®. Mixtures of these various materials may also be used as surface coatings. Illustrative commercial companies which produce materials that can be used in the surface coatings including, but are not limited to, Dow Corning (Midland, Mich.), Sandstrom (Port Byron, Ill.), and Sun Coating Company (Plymouth, Mich.). As noted herein, the surface coating material can be used in particle form, powder form or other forms which can be easily applied to the textured coating. The textured coating can be pre-heated prior to application of the surface coating or may remain at room temperature or be cooled. Similarly, the surface coating material can be heated (or cooled) prior to application to the textured coating.

In some configurations, the surface coating is typically disposed on the textured coating using a non-electrodeposition process, such as, for example, spraying, brushing, dipping, spreading, jet coating, sol gel processing or other processes. In some examples, the average particle size of the surface coating, prior to disposition, may be about 50% less, 40% less, 30% less or 25% less than the first size, e.g., the average characteristic length, of the microstructures of the textured coating. For example, the textured coating may be electrodeposited onto the substrate, and SEM images or other suitable techniques can be used to determine an average characteristic length of the microstructures of the textured coating. The average particle size of the surface coating to be applied to the textured coating may then be selected to be less than the average characteristic length of the microstructures. Without wishing to be bound by any particular application method, a dispersion of particles comprising the surface coating material is typically produced. This dispersion may comprise an aqueous carrier, an organic carrier or mixtures thereof as desired to permit application of the surface coating material to the electrodeposited textured coating. Post-application of the surface coating material, the article can be subjected to other treatment steps including, but not limited to, drying, heating, cooling, blotting, annealing, tempering, consolidating, sanding, etching, polishing or other physical or chemical steps.

In some examples, an additional layer of material can be applied to the applied surface coating if desired. In other instances, the textured coating, the surface coating or both may each comprise one or more additional materials such as a polymeric material. The additional material (or additional layer) can be selected from the group including, but not limited, to organic polymers, thermoplastic polymers, thermosetting polymers, copolymers, terpolymers, a block copolymer, an alternating block copolymer, a random polymer, homopolymer, a random copolymer, a random block copolymer, a graft copolymer, a star block copolymer, a dendrimer, a poly electrolyte (polymers that have some repeat groups that contains electrolytes), a poly ampholyte (Poly ampholytes are polyelectrolytes with both cationic and anionic repeat groups. There are different types of poly ampholyte. In the first type, both anionic and cationic groups can be neutralized. In the second type, anionic group can be neutralized, while cationic group is a group insensitive to pH changes such as a quaternary alkyl ammonium group. In the third type, cationic group can be neutralized and anionic group is selected from those species such as sulfonate groups that are showing no response to pH changes. In the fourth type, both anionic and cationic groups are insensitive to the useful range of pH changes in the solution.), ionomers (an ionomer is a polymer comprising repeat units of electrically neutral and ionized units. Ionized units are covalently bonded to the polymer backbone as pendant group moieties and usually consist mole fraction of no more than 15 mole percent), oligomers, cross-linkers, or any combination thereof. Examples of organic polymers include, but are not limited, to polyacetals, polyolefins, polyacrylics, polycarbonates, polystyrenes, polyesters, polyamides, polyamidimides, polyacrylates, polyarylsulfones, polyethersulfones, polyphenylene sulfides, polyvinylchlorides, polysulfones, polyimides, polyetherimides, polytetrafluoroethylenes, polyether ketone ketones, polybenzoxazoles, polyphthalides, polyacetals, polyanhydrides, polyvinyl ethers, polyvinyl thioethers, polyvinyl alcohols, polyvinyl ketones, poly vinyl halides, polyvinyl nitriles, polyvinyl esters, polysulfonates, poly sulfides, polythioesters, polysulfones, polysulfonamides, polyureas, polyphosphazenes, polysilazanes, styrene acrylonitrile, acrylonitrile-butadiene-styrene (ABS), polyethylene terephthalate, polybutylene terephthalate, polyurethane, ethylene ptopylene diene rubber (EPR), perfluoroelastomers, fluorinated ethylene propylene, perfluoroalkoxyethylene, poly-chlorotrifluoroethylene, polyvinylidene fluoride, polysiloxanes, or any combination thereof. Examples of polyelectrolytes include, but are not limited to, polystyrene sulfonic acid, polyacrylic acid, pectin, carrageenan, alginates, carboxymethylcellulose, polyvinylpyrrolidone, or any combination thereof. Examples of thermosetting polymers include, but are not limited to, epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, urea-formaldehyde polymers, novolacs, resoles, melamine-formaldehyde polymers, urea-formaldehyde polymers, hydroxymethylfuranes, isocyanates, diallyl phthalate, triallyl cyanurate, triallyl isocyanurate, unsaturated polysterimides, or any combination thereof. Examples of thermoplastic polymers include, but are not limited to, acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, poly sulfone/acrylonitrile-butadiene-styrene, polycarbonate/thermoplastic urethane, polycarbonate/polybutylene terephthalate, thermoplastic elastomer alloys, nylon/elastomers, polyester/elastomers, polyethylene terephthalate/polybutylene terephthalate, acetal/elastomer, styrene maleic anhydride/acrylonitrile-butadiene-styrene, polyether etherketone/polyethersulfone, polyether, etherketone/polyetherimide polyethylene/nylon, polyethylene/polyacetal, or any combination thereof.

In certain examples, processes other than electrodeposition processes can also be used in production of the textured coatings. The textured coating can be made, for example, through a process comprising a combination of the electrodeposition techniques and any other technique selected from the group consisting of annealing and thermal processing, vacuum conditioning, aging, plasma etching, grit blasting, wet etching, ion milling, exposure to electromagnetic radiation such as visible light, UV, and x-ray, other processes, and combinations thereof. In addition, the manufacturing process of the textured coating can be followed by at least one additional coating process selected from the group consisting of electrodeposition, electroless deposition, surface functionalization, electro-polymerization, spray coating, brush coating, dip coating, electrophoretic deposition, reaction with fluorine gas, plasma deposition, brush plating, chemical vapor deposition, sputtering, physical vapor deposition, passivation through the reaction of fluorine gas, any other coating technique, and any combination thereof.

In certain instances, the textured coating, surface coating or both can exhibit heat-resistant characteristics. This characteristic is observed if water contact angle of the coating changes less than 20 percent after the coating is subjected to a thermal process at 100° C. or higher for 12 hours or longer.

In certain embodiments, the textured coatings and/or surface coatings disposed thereon can be considered mechanically durable. Mechanical durability can be defined based on two criteria of hardness and pull-off (tape) tests. The hardness criterion is defined based on the pencil hardness level of more than 3B corresponding to the ASTM D3363-05(2011)e2 standard measurement. This test method determines the hardness of a coating by drawing pencil lead marks from known pencil hardness on the coating surface. The film hardness is determined based on the hardest pencil that will not rupture or scratch the film. A set of calibrated drawing leads or calibrated wood pencils meeting the following scales of hardness were used: 9H-8H-7H-6H 5H 4H 3H 2H H-F-HB-B 2B 3B 4B 5B 6B 7B 8B 9B. 9B grade corresponds to the lowest level of hardness and represents very soft coatings. The hardness level increases gradually after that until it gets to the highest level of 9H. The difference between two adjacent scales can be considered as one unit of hardness.

In addition to the pencil hardness, durability of the textured coating and/or surface coating can be characterized using the standard ASTM procedure for the tape test (ASTM F2452-04-2012). This attribute of durability is defined based on exhibiting at least level three of durability among five levels defined by the standard test. In this test, a tape is adhered to the surface and pulled away sharply. The level of the coating durability obtained based on the amount of the coating removed from the surface and attached to the tape. The lowest to highest durability is rated from 1 to 5, respectively. A lower rating means that some part of the coating is removed by the tape, and therefore, a part of the coating functionality is lost. A rating of 5 corresponds to the condition that zero amount of coating is removed. Therefore, the functionally of the coating at this rate remains the same after and before the tape test.

In addition to the pencil hardness and tape tests, a Tabor abrasion test is another test that can be performed on the textured coating and/or surface coating described herein. In this test, the coated samples are subjected to several cycles of abrasive wheels with 500 g loading weight at 60 rpm speed. The mass loss percentage (%) of the coatings is then calculated for each individual sample based on the ratio of mass loss to the initial mass of the coating.

In some embodiments, the articles produced using the coatings described herein may be considered easy-clean coatings. Easy-clean characteristic is defined, wherein in a cleanability test, at least 80 percent of the surface can be cleaned. In this test, the coating is painted with cooking oil and placed in an oven at 100° C. for 12 hours. It can then be wiped out with a wet tissue. Easy-clean characteristic is also related to the coating oleophobicity. The oleophobic characteristic can be measured by the contact angle of oil on a surface.

Certain configurations of the combined textured and surface coatings described herein can also provide one or more of the following attributes: reduce transfer from/to the surface, provide protection, prevent or discourage adhesion of water and microscale/nanoscale objects, or a combination of said functionalities. The combined coatings can be used in many different applications including but not limited to, wetting, dirt accumulation, corrosion, microbial adhesion and disease transformation, ice formation, friction and drag and biofouling prevention and/or mitigation. For instance, the coatings can protect, to at least some degree, an article, e.g. vehicle or other components, against detrimental effects of the environment, e.g. corrosion and fouling, which reduce the overall useful lifetime of the article or cause fading or deterioration. The coatings can be used in equipment with high-temperature working conditions such as ovens. heat-exchangers, piping, tubing and condensers. It can be used to mitigate sticky problems at high temperature environments. As another instance, certain configurations of coatings can discourage transfer of liquids, dirt, microorganisms, viruses, or particles from/to an article to/from human and animals upon contact, which can reduce cross contamination.

In some examples, the pull-off strength of the surface coatings described herein, when tested by ASTM D4541-09, may be at least 200 psi or 225 psi or 250 psi when the textured coating is present. In other instances, the pull-off strength of the surface coating can increase by at least 10%, 20%, 30%, 40%, 50% or more when the textured coating is present on the substrate as compared to the pull-off strength when the textured coating is absent from the substrate.

In some instances, the combined textured and surface coatings disclosed in the embodiments described herein may be present on an article selected from the group consisting of faucets, door knobs, flush toilets, bathroom fittings, pens, bed-rails, trays, hand-dryers, any appliances, tables, desks, molds, pipes, medical devices and implants, automotive vehicles, airplanes, ambulances, high touch surfaces in hospitals, surfaces in cleanroom, biomedical and food packaging, surfaces in public transit areas, surfaces in swimming pools, surfaces in public bathrooms, electronics glass screens, ovens, grills, ranges, heat-exchangers, condensers, ships, ship hulls, cellphone cases, utensil handles and the like.

In certain embodiments, a method of increasing adhesion of a surface coating to an article comprises providing a textured coating on a substrate by electrodepositing the textured coating, and disposing the surface coating on the electrodeposited, textured coating, e.g., disposing a surface coating comprising a repellent material, a material with water contact angle of at least 90 degrees, etc. on the textured coating. In some examples, the pull-off strength of the disposed surface coating in the absence of the electrodeposited, textured coating is lower than in the presence of the electrodeposited, textured coating.

In certain configurations, the method comprises disposing at least one repellent material as the surface coating. In some examples, the method comprises configuring the at least one repellent material to comprise one or more of a silicone polymer, e.g., polydimethylsiloxane, a fluorinated polymer, e.g., polytetrafluorethylene, an oligomeric siloxane, e.g., fluorinated-base oligomeric siloxane, a ceramic material, e.g., hydrophobic silica particles or alumina particles, a metal compound e.g., molybdenum disulfide, and combinations thereof. In other examples, the method comprises, configuring the substrate as steel comprising different grades of carbon steel or stainless steel. In some embodiments, the method comprises configuring the electrodeposited, textured coating to comprise microstructures of an average characteristic length that comprise at least one metal or metallic compound and a plurality of individual microstructures, wherein the plurality of individual microstructures are positioned in different planes and in different heights with respect to a reference zero point in the electrodeposited, textured coating. In other examples, the method comprises selecting an average particle size of material of the surface coating to be less than the average characteristic length of the plurality of individual microstructures. In some embodiments, the method comprises electrodepositing the textured coating on each external surface of the substrate, and disposing the surface coating on at least one external surface of the substrate comprising the electrodeposited, textured coating. In other examples, the method comprises disposing the surface coating on internal surfaces of the substrate comprising the electrodeposited, textured coating. In certain examples, the method comprises disposing a second textured coating on the electrodeposited, textured coating prior to disposal of the surface coating. In some configurations, the method comprises heating the disposed surface coating to permit infusion of material of the surface coating into pores of the electrodeposited, textured coating, and wherein after addition of the surface coating a surface roughness of the article decreases compared to a surface roughness of the article before addition of the surface coating to the textured coating. In other configurations, the method comprises selecting material of the surface coating to provide a pull-off strength at least 10% greater when the electrodeposited, textured coating is present than a pull-off strength in the absence of the electrodeposited, textured coating when pull-off strength is tested using ASTM D4541-09. In other examples, the method comprises selecting the material of the surface coating to provide a pull-off strength of at least 200 psi as tested by ASTM D4541-09 when the electrodeposited, textured coating is present. In some examples, the method comprises selecting the substrate to comprise steel or a steel alloy. In some instances, the method comprises selecting material of the electrodeposited, textured coating to comprise nickel, zinc, chromium, copper, zinc/nickel alloys, zinc/copper alloys, chromium alloys and combinations thereof. In certain instances, the method comprises selecting material of the surface coating to comprise one or more of a silicone polymer, e.g., polydimethylsiloxane, a fluorinated polymer, e.g., polytetrafluorethylene, an oligomeric siloxane, e.g., fluorinated-base oligomeric siloxane, a ceramic material, e.g., hydrophobic silica particles or alumina particles, a metal compound e.g., molybdenum disulfide, and combinations thereof. In some embodiments, the method comprises electrodepositing the textured coating on the substrate without any physical pre-pretreatment of the substrate. In further examples, the method comprises selecting the substrate to be a non-anodizable substrate. In some embodiments, the method comprises electrodepositing the textured coating in the presence of at least one additional material. In other examples, the method comprises selecting the additional material to comprise one or more of a silicone polymer, e.g., polydimethylsiloxane, a fluorinated polymer, e.g., polytetrafluorethylene, an oligomeric siloxane, e.g., fluorinated-base oligomeric siloxane, a ceramic material, e.g., hydrophobic silica particles or alumina particles, a metal compound e.g., molybdenum disulfide, and combinations thereof. In some examples, the method comprises disposing an additional layer on the surface coating.

In other embodiments, method comprises electrodepositing a textured coating on the substrate using an electrolyte solution comprising a mixture of at least one metal or metallic compound, wherein the textured coating comprises a plurality of individual microstructures of an average characteristic length which comprise the metal or metallic compound, wherein the plurality of individual microstructures are positioned in different planes and in different heights with respect to a reference zero point in the electrodeposited, textured coating, and disposing the surface coating on the electrodeposited textured coating by applying a repellent material onto the electrodeposited textured coating, wherein an average particle size of particles of the repellent material is selected to be less than the average characteristic length of the plurality of individual microstructures of the electrodeposited, textured coating, and wherein pull-off strength of the disposed surface coating in the absence of the electrodeposited, textured coating is lower than in the presence of the electrodeposited, textured coating, e.g., when the pull-off strength is tested by ASTM D4541-09.

In certain examples, the method comprises configuring the electrolyte solution with a hydrophobic material dispersed in the electrolyte solution. In other examples, the method comprises configuring the hydrophobic material to comprise one or more of a fluoropolymer, a silicon polymer, a ceramic and combinations thereof. In some examples, the method comprises configuring the at least one repellent material to comprise one or more of a silicone polymer, e.g., polydimethylsiloxane, a fluorinated polymer, e.g., polytetrafluorethylene, an oligomeric siloxane, e.g., fluorinated-base oligomeric siloxane, a ceramic material, e.g., hydrophobic silica particles or alumina particles, a metal compound e.g., molybdenum disulfide, and combinations thereof. In some embodiments, the method comprises configuring the substrate as steel comprising different grades of carbon steel or stainless steel. In other embodiments, the method comprises configuring the electrodeposited, textured coating to comprise microstructures of an average characteristic length that comprise at least one metal or metallic compound and a plurality of microstructures, wherein the plurality of individual microstructures are positioned in different planes and in different heights with respect to a reference zero point in the electrodeposited, textured coating. In some examples, the method comprises electrodepositing the textured coating on each external surface of the substrate, and disposing the surface coating on at least one external surface of the substrate comprising the electrodeposited, textured coating. In other examples, the method comprises disposing the surface coating on internal surfaces of the substrate comprising the electrodeposited, textured coating. In some embodiments, the method comprises disposing a second textured coating on the electrodeposited, textured coating prior to disposal of the surface coating. In some instances, the method comprises heating the disposed surface coating to permit infusion of material of the surface coating into pores of the electrodeposited, textured coating, wherein after heating a porosity of the electrodeposited, textured coating is about zero. In certain configurations, the method comprises selecting material of the surface coating to provide a pull-off strength at least 10% greater when the electrodeposited textured coating is present than a pull-off strength in the absence of the electrodeposited, textured coating when pull-off strength is tested using ASTM D4541-09. In some examples, the method comprises selecting the material of the surface coating to provide a pull-off strength of at least 200 psi as tested by ASTM D4541-09 when the electrodeposited, textured coating is present. In some examples, the method comprises selecting the substrate to comprise steel or a steel alloy. In other examples, the method comprises selecting material of the electrodeposited textured coating to comprise nickel, zinc, chromium, copper, zinc/nickel alloys, zinc/copper alloys, chromium alloys and combinations thereof. In additional examples, the method comprises selecting the repellent material of the surface coating to comprise one or more of a silicone polymer, e.g., polydimethylsiloxane, a fluorinated polymer, e.g., polytetrafluorethylene, an oligomeric siloxane, e.g., fluorinated-base oligomeric siloxane, a ceramic material, e.g., hydrophobic silica particles or alumina particles, a metal compound e.g., molybdenum disulfide, and combinations thereof. In some examples, the method comprises electrodepositing the textured coating on the substrate without any physical pre-pretreatment of the substrate. In other examples, the method comprises selecting the substrate to be a non-anodizable substrate. In some embodiments, the method comprises electrodepositing the textured coating in the presence of at least one additional material. In other examples, the method comprises selecting the additional material to comprise one or more of a silicone polymer, a fluorinated polymer, an oligomeric siloxane, a ceramic-based material comprising hydrophobic silica particles, a metal based compound comprising molybdenum disulfide, and combinations thereof. In certain examples, the method comprises disposing an additional layer on the surface coating.

In certain embodiments, a kit comprising a substrate, a material to be applied as a textured coating and a material to be applied as a surface coating is provided. For example, the material for the textured coating may comprise nickel, zinc, chromium, copper, zinc/nickel alloys, zinc/copper alloys, chromium alloys and combinations thereof. The material for the textured coating may also comprise silicon carbide, polytetrafluoroethylene, silicon oxide, diamond, titanium dioxide or silicon oxide particles, microparticles or nanoparticles. The material for the surface coating may comprise one or more repellent materials such as, for example, one or more of a silicone polymer, e.g., polydimethylsiloxane, a fluorinated polymer, e.g., polytetrafluorethylene, an oligomeric siloxane, e.g., fluorinated-base oligomeric siloxane, a ceramic material, e.g., hydrophobic silica particles or alumina particles, a metal compound e.g., molybdenum disulfide, and combinations thereof. If desired, the kit may also comprise instructions for using the various materials to provide an article including the substrate, the textured coating and the surface coating.

In other embodiments, a kit may comprise an electrolyte solution, or materials which can be used to prepare an electrolyte solution, and instructions for using the electrolyte solution to provide an electrodeposited textured coating on a substrate. For example, the electrolyte solution can be prepared from materials comprising nickel, zinc, chromium, copper, zinc/nickel alloys, zinc/copper alloys, chromium alloys and combinations thereof. The materials for preparing the electrolyte solution may also comprise silicon carbide, polytetrafluoroethylene, silicon oxide, diamond, titanium dioxide or silicon oxide particles, microparticles or nanoparticles. In some examples, the kit may also comprise a surface coating material and instructions for applying the surface coating material to the electrodeposited, textured coating. For example, one or more of a silicone polymer, e.g., polydimethylsiloxane, a fluorinated polymer, e.g., polytetrafluorethylene, an oligomeric siloxane, e.g., fluorinated-base oligomeric siloxane, a ceramic material, e.g., hydrophobic silica particles or alumina particles, a metal compound e.g., molybdenum disulfide, and combinations thereof, and the like can be present and used in the surface coating. In further embodiments, the kit may comprise the substrate itself. For example, the substrate may be steel, a steel alloy, steel comprising different grades of carbon steel or stainless steel. Other components may also be present in the kit.

### EXAMPLE 1

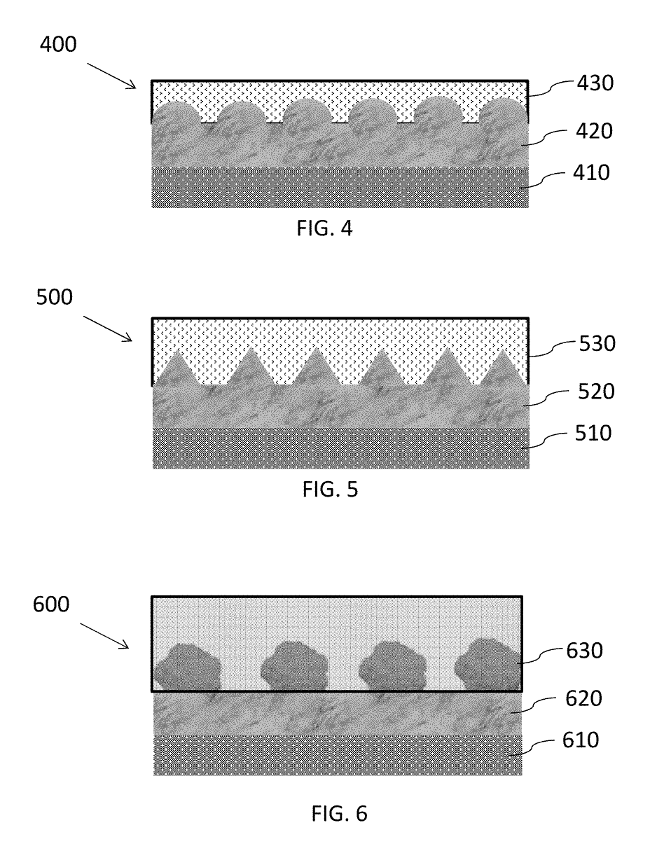

An article can be produced by applying a surface coating to a textured coating present on a substrate. Referring to FIG. 4, a steel, steel alloy, steel comprising different grades of carbon steel or stainless steel substrate 410 comprises a textured coating 420. The textured coating 420 can be produced by electrodeposition of one or more of nickel, zinc, chromium, copper, zinc/nickel alloys, zinc/copper alloys, chromium alloys and other transition metals and combinations thereof. In this configuration, the textured coating 420 comprises a regular geometry of spherical microstructures of a first characteristic length in the textured coating 420.

A surface coating 430 can then be applied to the textured coating 420 by spraying, brushing, dipping or other means. In some examples, the surface coating 430 is applied using surface coating material with an average particle size less than the first characteristic length. The surface coating 430 may comprise one or more of a fluoropolymer such as polytetrafluoroethylene, a ceramic such as silica, or a metal based compounds such as molybdenum disulfide. The article 400 can be used, for example, as a panel, side or some component of an oven, a heat-exchanger, tubing, piping and a condenser.

### EXAMPLE 2

An article can be produced by applying a surface coating to a textured coating present on a substrate. Referring to FIG. 5, a steel, steel alloy, steel comprising different grades of carbon steel or stainless steel substrate 510 comprises a textured coating 520. The textured coating 520 can be produced by electrodeposition of one or more of nickel, zinc, chromium, copper, zinc/nickel alloys, zinc/copper alloys, chromium alloys and other transition metals and combinations thereof. In this configuration, the textured coating 520 comprises a regular geometry of pyramidal microstructures of a first characteristic length in the textured coating 520.

A surface coating 530 can then be applied to the textured coating 520 by spraying, brushing, dipping or other means. In some examples, the surface coating 530 is applied using surface coating material with an average particle size less than the first characteristic length. The surface coating 530 may comprise one or more of a fluoropolymer such as polytetrafluoroethylene, a ceramic such as silica, or a metal based compounds such as molybdenum disulfide. The article 500 can be used, for example, as a panel, side or some component of an oven, a heat-exchanger, tubing, piping and a condenser.

### EXAMPLE 3

An article can be produced by applying a surface coating to a textured coating present on a substrate. Referring to FIG. 6, a steel, steel alloy, steel comprising different grades of carbon steel or stainless steel substrate 610 comprises a textured coating 620. The textured coating 620 can be produced by electrodeposition of one or more of nickel, zinc, chromium, copper, zinc/nickel alloys, zinc/copper alloys, chromium alloys and other transition metals and combinations thereof. In this configuration, the textured coating 620 comprises an irregular geometry of microstructures of a first characteristic length in the textured coating 620.

A surface coating 630 can then be applied to the textured coating 620 by spraying, brushing, dipping or other means. In some examples, the surface coating 630 is applied using surface coating material with an average particle size less than the first characteristic length. The surface coating 630 may comprise one or more of a fluoropolymer such as polytetrafluoroethylene, a ceramic such as silica, or a metal based compounds such as molybdenum disulfide. The article 600 can be used, for example, as a panel, side or some component of an oven, a heat-exchanger, tubing, piping and a condenser.

### EXAMPLE 4

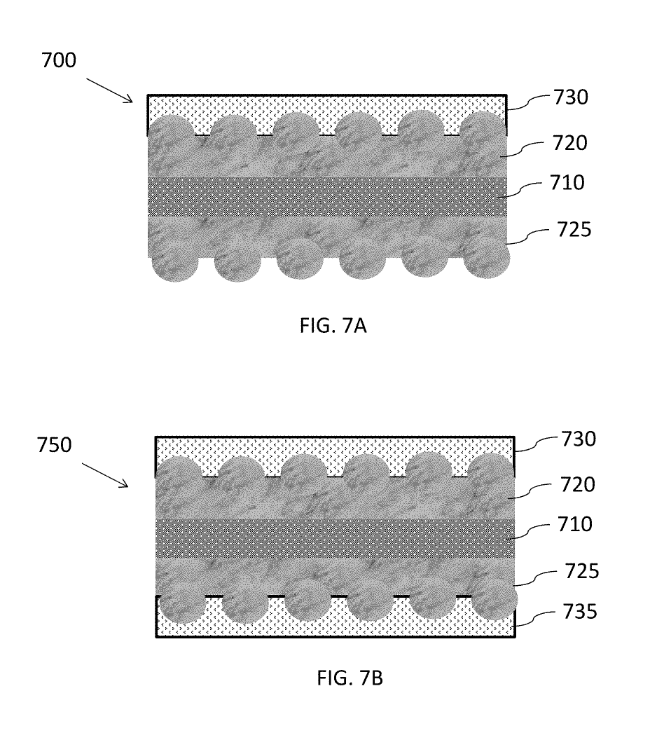

An article can be produced by applying a surface coating to a textured coating present on each side of a substrate. Referring to FIG. 7A, a steel, steel alloy, steel comprising different grades of carbon steel or stainless steel substrate 710 comprises a textured coating 720 on a first surface of the substrate 710 and a textured coating 725 on a second surface of the substrate 710. The textured coatings 720, 725 may be the same or may be different. One or both of the textured coatings 720, 725 can be produced by electrodeposition of one or more of nickel, zinc, chromium, copper, zinc/nickel alloys, zinc/copper alloys, chromium alloys and other transition metals and combinations thereof. In this configuration, each of the textured coatings 720, 725 comprises a regular geometry of spherical microstructures of a first characteristic length in the textured coatings 720, 725. The characteristic length of the microstructures may be the same or may be different in the textured coatings 720, 725. In some examples, the textured coatings 720, 725 may comprise similar materials but may have different microstructure geometries.

A surface coating 730 can then be applied to the textured coating 720 by spraying, brushing, dipping or other means. In some examples, the surface coating 730 is applied using surface coating material with an average particle size less than the first characteristic length of the microstructures of the textured coating 720. The surface coating 730 may comprise one or more of a fluoropolymer such as polytetrafluoroethylene, a ceramic such as silica, or a metal based compound such as molybdenum disulfide. The article 700 can be used, for example, as a panel, side or some component of an oven, a heat-exchanger, and a condenser. As noted herein, the surface coating can be present on internal surfaces of an article which mays contact a material such as food, solvents or the like and to reduce cost, external surfaces not exposed to the foods, solvents, etc. may or may not include the surface coating and/or the textured coating.

In another configuration (see FIG. 7B), a surface coating 735 can also be applied to the textured coating 725. The surface coatings 730, 735 can be the same or they can be different. In some examples, the surface coating 735 is applied using surface coating material with an average particle size less than the first characteristic length of the microstructures of the textured coating 725. The surface coating 730 may comprise one or more of a fluoropolymer such as polytetrafluoroethylene, a ceramic such as silica, or a metal based compound such as molybdenum disulfide. The article 750 can be used, for example, as a panel, side or some component of an oven, a heat-exchanger, tubing, piping and a condenser.

### EXAMPLE 5

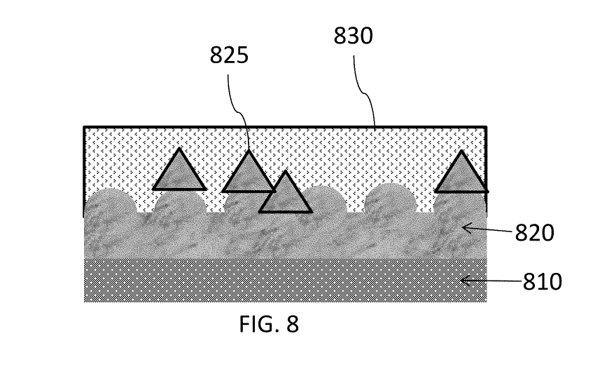

An article can be produced by applying a surface coating to two or more textured coatings present on each side of a substrate. Referring to FIG. 8, a steel, steel alloy, steel comprising different grades of carbon steel or stainless steel substrate 810 comprises a first textured coating 820 on a first surface of the substrate 810. On the same surface of the substrate 810 and on the first textured coating 820, a second textured coating 830 has been disposed. The textured coatings 820, 825 may be the same or may be different. One or both of the textured coatings 820, 825 can be produced by electrodeposition of one or more of nickel, zinc, chromium, copper, zinc/nickel alloys, zinc/copper alloys, chromium alloys and other transition metals and combinations thereof. In this configuration, each of the textured coatings 820, 825 comprises a different geometry of microstructures. The characteristic length of the microstructures may be the same or may be different in the textured coatings 820, 825. In some examples, the textured coatings 820, 825 may comprise similar materials but may have different microstructure geometries.

A surface coating 830 can then be applied to the textured coatings 820, 825 by spraying, brushing, dipping or other means. In some examples, the surface coating 830 is applied using surface coating material with an average particle size less than the first characteristic length of the microstructures of the textured coatings 820. 825. The surface coating 830 may comprise one or more of a fluoropolymer such as polytetrafluoroethylene, a ceramic such as silica, or a metal based compound such as molybdenum disulfide. The article 800 can be used, for example, as a panel, side or some component of an oven a heat-exchanger. and a condenser.

In another configuration (see FIG. 7B), a surface coating 735 can also be applied to the textured coating 725. The surface coatings 730, 735 can be the same or they can be different. In some examples, the surface coating 735 is applied using surface coating material with an average particle size less than the first characteristic length of the microstructures of the textured coating 725. The surface coating 730 may comprise one or more of a fluoropolymer such as polytetrafluoroethylene, a ceramic such as silica, or a metal based compound such as molybdenum disulfide. The article 750 can be used, for example, as a panel, side or some component of an oven, a heat-exchanger, tubing, piping and a condenser.

When introducing elements of the aspects, embodiments, configurations, examples, etc. disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. A method of increasing adhesion of a surface coating to an article, the method comprising:
providing a textured coating on a substrate by electrodepositing the textured coating; and
disposing the surface coating on the electrodeposited, textured coating, wherein the pull-off strength of the disposed surface coating in the absence of the electrodeposited, textured coating is lower than in the presence of the electrodeposited, textured coating.

2. The method of claim 1, disposing at least one repellent material as the surface coating.

3. The method of claim 1, configuring the at least one repellent material to comprise one or more of a silicone polymer, a fluorinated polymer, an oligomeric siloxane, a ceramic material, a metal compound, and combinations thereof.

4. The method of claim 1, configuring the substrate as steel comprising different grades of carbon steel or stainless steel.

5. The method of claim 1, further comprising configuring the electrodeposited, textured coating to comprise microstructures of an average characteristic length that comprise at least one metal or metallic compound and a plurality of individual microstructures, wherein the plurality of individual microstructures are positioned in different planes and in different heights with respect to a reference zero point in the electrodeposited, textured coating.

6. The method of claim 5, further comprising selecting an average particle size of material of the surface coating to be less than the average characteristic length of the plurality of individual microstructures.

7. The method of claim 1, further comprising electrodepositing the textured coating on each external surface of the substrate, and disposing the surface coating on at least one external surface of the substrate comprising the electrodeposited, textured coating.

8. The method of claim 7, further comprising disposing the surface coating on internal surfaces of the substrate comprising the electrodeposited, textured coating.

9. The method of claim 1, further comprising disposing a second textured coating on the electrodeposited, textured coating prior to disposal of the surface coating.

10. The method of claim 1, further comprising heating the disposed surface coating to permit infusion of material of the surface coating into pores of the electrodeposited, textured coating, and wherein after addition of the surface coating a surface roughness of the article decreases compared to a surface roughness of the article before addition of the surface coating to the textured coating.

11. The method of claim 1, further comprising selecting material of the surface coating to provide a pull-off strength at least 10% greater when the electrodeposited, textured coating is present than a pull-off strength in the absence of the electrodeposited, textured coating when pull-off strength is tested using ASTM D4541-09.

12. The method of claim 11, further comprising selecting the material of the surface coating to provide a pull-off strength of at least 200 psi as tested by ASTM D4541-09 when the electrodeposited, textured coating is present.

13. The method of claim 11, further comprising selecting the substrate to comprise steel or a steel alloy.

14. The method of claim 13, further comprising selecting material of the electrodeposited, textured coating to comprise nickel, zinc, chromium, copper, zinc/nickel alloys, zinc/copper alloys, chromium alloys and combinations thereof.

15. The method of claim 14, further comprising selecting material of the surface coating to comprise one or more of a silicone polymer, a fluorinated polymer, an oligomeric siloxane, a ceramic material, a metal compound, and combinations thereof.

16. The method of claim 1, further comprising electrodepositing the textured coating on the substrate without any physical pre-pretreatment of the substrate.

17. The method of claim 1, further comprising selecting the substrate to be a non-anodizable substrate.

18. The method of claim 1, further comprising electrodepositing the textured coating in the presence of at least one additional material.

19. The method of claim 18, further comprising selecting the additional material to comprise one or more of a silicone polymer, a fluorinated polymer, an oligomeric siloxane, a ceramic material, a metal compound, and combinations thereof.

20. The method of claim 19, further comprising disposing an additional layer on the surface coating.

21-60. (canceled)
